(19) United States
(12) Patent Application Publication
(10) Pub. No.: US 2010/0101441 A1
(43) Pub. Date: Apr. 29, 2010

(54) Offset Printing Transfer Cylinder Base Cover with Alignment Stripes for Precision Installation of a Flexible Jacket Cover also with Alignment Stripes

(75) Inventors: Howard W. DeMoore, Dallas, TX (US); Joey V. Le, Arlington, TX (US)

Correspondence Address: CONLEY ROSE, P.C., 5601 GRANITE PARKWAY, SUITE 750, PLANO, TX, 75024, US

(73) Assignee: PRINTING RESEARCH, INC., Dallas, TX (US)

(21) Appl. No.: 12/258,225

(22) Filed: Oct. 24, 2008

(51) Int. Cl. B41F 3/34

(52) U.S. Cl. 101/492

(57) ABSTRACT

In a printing unit having a transfer cylinder for transferring a freshly printed substrate, a flexible jacket having at least one horizontally disposed first means for visual alignment is disclosed and a cylinder base cover having at least one horizontally disposed second means for visual alignment is disclosed, wherein the first means for visual alignment and the second means for visual alignment are used in combination during at least one of attaching the flexible jacket to the transfer cylinder over the cylinder base cover and adjusting the free play of the flexible jacket, wherein the flexible jacket is movable relative to the cylinder base cover.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

In the operation of a rotary offset printing press, freshly printed substrates such as sheets or web material are guided by transfer cylinders or the like from one printing unit to another, and then they are delivered to a sheet stacker or to a sheet folder/cutter unit, respectively. As used herein, the term “transfer cylinder” includes delivery cylinders, transfer rollers, support rollers, support cylinders, delivery wheels, skeleton wheels, segmented wheels, transfer drums, support drums, spider wheels, support wheels, guide wheels, guide rollers and the like.

The ink marking problems inherent in transferring freshly printed substrates have been longstanding. In order to minimize the contact area between the transfer means and the freshly printed substrate, conventional support wheels have been modified in the form of relatively thin disks having a toothed or serrated circumference, referred to as skeleton wheels. However, those thin disc transfer means have not overcome the problems of smearing and marking the freshly printed substrate due to moving contact between the freshly printed substrate and the projections or serrations. Moreover, the attempts to cover the transfer cylinder with a cover material and/or minimize the surface support area in contact with the freshly printed substrate material often resulted in further problems.

Various efforts have been made to overcome the limitations of thin disk skeleton wheels. One of the most important improvements has been completely contrary to the concept of minimizing the surface area of contact. That improvement is disclosed and claimed in my U.S. Pat. No. 3,791,644 to Howard W. DeMoore, incorporated by reference herein in its entirety, wherein the support surface of a transfer cylinder in the form of a wide wheel or cylinder is coated with an improved ink repellent surface formed by a layer of polytetrafluoroethylene (PTFE).

During the use of the PTFE coated transfer cylinders in high-speed commercial printing presses, the surface of the coated cylinders must be washed too frequently with a solvent to remove any ink accumulation. Moreover, it has also been determined that the PTFE coated cylinders do not provide a critically needed cushioning effect and relative movement.

The limitations on the use of the PTFE coated transfer cylinders have been overcome with an improved transfer cylinder having an ink repellent, cushioning and supportive fabric covering or the like for transferring the freshly printed sheet. It is now well recognized and accepted in the printing industry world-wide that marking and smearing of freshly printed sheets caused by engagement of the wet printed surface with the supporting surface of a conventional press transfer cylinder is substantially eliminated by using the anti-marking fabric covering system as disclosed and claimed in my U.S. Pat. No. 4,402,267 entitled “Method and Apparatus for Handling Printed Substrate Material”, the disclosure of which is incorporated herein by reference.

That system, which is marketed under license by Printing Research, Inc. of Dallas, Tex., U.S.A. under the registered trademark SUPER BLUE® includes the use of a low friction coating or coated material on the supporting surface of the transfer cylinder, and over which is loosely attached a movable fabric covering. The fabric covering provided a yieldable, cushioning support for the freshly printed side of the substrate such that relative movement between the freshly printed substrate and the transfer cylinder surface would take place between the fabric covering and the support surface of the transfer cylinder so that marking and smearing of the freshly printed surface was substantially reduced. Various improvements have been made to the SUPER BLUE system, which are described in more detail in U.S. Pat. Nos. 5,907,998 and 6,244,178 each entitled “Anti-Static, Anti-Smearing Pre-Stretched and Pressed Flat, Precision-Cut Striped Flexible Coverings for Transfer Cylinders”; U.S. Pat. Nos. 5,511,480, 5,603,264, 6,073,556, and 6,119,597 each entitled “Method and Apparatus for Handling Printed Sheet Material”; U.S. Pat. No. 6,192,800 entitled “Method and Apparatus for Handling Printed Sheet Material”; U.S. Pat. No. 5,979,322 entitled “Environmentally Safe, Ink Repellent, Anti-Marking Flexible Jacket Covering Having Alignment Stripes, Centering Marks and Pre-Fabricated Reinforcement Strips for Attachment onto Transfer Cylinders in a Printing Press”; and RE39,305 entitled “Anti-static, Anti-smearing Pre-stretched and Pressed Flat, Precision-cut Striped Flexible Coverings for Transfer Cylinders”, each of which is hereby incorporated by reference herein in its entirety. The above cited patents are all owned by Printing Research, Inc. of Dallas, Tex., U.S.A.

### SUMMARY

In a first embodiment, in a printing unit having a transfer cylinder for transferring a freshly printed substrate, a flexible jacket having at least one horizontally disposed first means for visual alignment is disclosed and a base cover having at least one horizontally disposed second means for visual alignment is disclosed, wherein the first means for visual alignment and the second means for visual alignment are used in combination during at least one of attaching the flexible jacket to the transfer cylinder over the base cover and adjusting the free play of the flexible jacket, wherein the flexible jacket is movable relative to the base cover.

In an embodiment, a printing unit is disclosed having a transfer cylinder for transferring a freshly printed substrate having a base cover attached to the transfer cylinder and having a flexible jacket attached to the transfer cylinder over the base cover. The base cover is characterized as comprising a first horizontal visual stripe. The flexible jacket is characterized as comprising a sheet of flexible material having a second horizontal visual stripe for use, in combination with the first horizontal visual stripe, for visually aligning during attaching the flexible jacket to the transfer cylinder in an operative position wherein the flexible jacket is movable relative to the base cover.

In an embodiment, a method of manufacturing a base cover for use in covering a transfer cylinder in a printing unit is provided. The base cover comprises at least one longitudinally disposed visual alignment means for visually aligning during attaching a flexible jacket to the transfer cylinder over the base cover and adjusting free play in the flexible jacket. The method comprises weaving a flexible fabric material using warp and weft threads, wherein a weft thread is periodically omitted from the fabric material and wherein the omitted weft thread defines the at least one longitudinally disposed visual alignment means of the base cover.

In an embodiment, a method of attaching a flexible jacket over a transfer cylinder of a printing unit is provided. The method comprises attaching a base cover to the transfer cylinder, the base cover having at least one horizontally disposed cover visual stripe and attaching a gripper edge of a flexible jacket to a gripper of the transfer cylinder, the flexible jacket having at least one horizontally disposed jacket visual stripe. The method also comprises pulling a tail edge of the flexible jacket smooth, moving the flexible jacket towards the gripper, aligning the at least one cover visual stripe with the at least one jacket visual stripe, wherein a free play of the flexible jacket is adjusted, and securing the tail edge of the flexible jacket to the transfer cylinder.

In an embodiment, a method of adjusting a flexible jacket attached to a transfer cylinder of a printing unit over a base cover attached to the transfer cylinder is provided. The base cover has at least one horizontally disposed cover visual stripe, and the flexible jacket has at least one horizontally disposed jacket visual stripe. The method comprises releasing the flexible jacket from the transfer cylinder at a tail edge of the flexible jacket and pulling the flexible jacket smooth at the tail edge of the flexible jacket. The method also comprises moving the flexible jacket towards the gripper, aligning the at least one cover visual stripe with the at least one jacket visual stripe, wherein a free play of the flexible jacket is adjusted, and securing the tail edge of the flexible jacket to the transfer cylinder.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1A is a perspective view of a base cover for a transfer cylinder according to an embodiment of the disclosure.

FIG. 1B is a view of a base cover according to an embodiment of the disclosure.

FIG. 1C is a sectional view of a base cover according to an embodiment of the disclosure.

FIG. 1D is an illustration of a base cover having visual alignment means according to an embodiment of the disclosure.

FIG. 1E is an illustration of a base cover having visual alignment means according to an embodiment of the disclosure.

FIGS. 1F-1, 1F-2, 1F-3, 1F-4, 1F-5, and 1F-6 are illustrations of different embodiments of visual stripes according to embodiments of the disclosure.

FIG. 1G is an illustration of a base cover having visual alignment means defined by one or more absent threads according to an embodiment of the disclosure.

FIG. 1H is an illustration of a base cover having visual alignment means defined by one or more absent threads with backing strips according to an embodiment of the disclosure.

FIG. 2A is a perspective view of a flexible jacket according to an embodiment of the disclosure.

FIG. 2B is a view of a flexible jacket having visual alignment means according to an embodiment of the disclosure.

FIG. 2C is a view of a flexible jacket having visual alignment means according to an embodiment of the disclosure.

FIG. 3A is a schematic side elevational view showing multiple transfer cylinders installed at substrate transfer positions in a four color rotary offset printing press of a type made by Heidelberg Druckmaschinen Aktiengesellschaft.

FIG. 3B is a schematic side elevational view showing multiple transfer cylinders installed at substrate transfer positions in a four color rotary offset printing press of the Lithrone Series made by Komori Corp.

FIG. 4 is a perspective view of a transfer cylinder of a type commonly used on printing presses made by Heidelberg Druckmaschinen Aktiengesellschaft.

FIG. 5A is a cross-sectional view of a transfer cylinder taken along line 15-15 of FIG. 4 having an integrated, anti-marking cover installed thereon.

FIG. 5B is a cross-sectional view of a transfer cylinder of a type commonly used on Lithrone Series printing presses made by Komori Corp.

FIG. 6 is a flow chart of a method of attaching a base cover and a flexible jacket to a transfer cylinder of a printing press according to an embodiment of the disclosure.

FIG. 7 is a flow chart of a method of adjusting a flexible jacket for use on a printing press according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or in existence. The disclosure should in no way be limited to the illustrative implementations, drawings, and techniques illustrated below, but may be modified within the scope of the appended claims along with their full scope of equivalents.

In an embodiment, a transfer cylinder may be at least partially enclosed by a cylinder base cover comprising at least one means for visual alignment disposed horizontally on the cylinder base cover. The cylinder base cover may be referred to as the base cover hereinafter. This means for visual alignment may be used in combination with a flexible Jacket comprising at least one means for visual alignment disposed horizontally on the flexible jacket. In some contexts, the flexible jacket may also be referred to as a net. The means for visual alignment disposed horizontally on the base cover and the means for visual alignment disposed horizontally on the flexible jacket may be used in combination to install and/or adjust the fit of the flexible jacket over the base cover. As discussed above, the flexible jacket is intended to provide a yieldable, cushioning support for the freshly printed side of a substrate. To achieve this yieldable, cushioning support it is desirable that the flexible jacket be installed and/or adjusted to have an appropriate amount of slack, looseness, and/or free play with respect to the base cover and/or the transfer cylinder. The means for visual alignment on the base cover may be used, in combination with the means for visual alignment on the flexible jacket, as a guide for adjusting the free play of the flexible jacket.

The means for visual alignment on the base cover and the means for visual alignment on the flexible jacket, in combination, may promote repeatable adjustments based on experience. Additionally, the means for visual alignment on the base cover and the means for visual alignment on the flexible jacket, in combination, may promote ease of conveying instructions from a first experienced press operator to a second less experienced or inexperienced press operator, for example from a remote support center via a telephone call. For example, in some circumstances a press operator and/or pressman may learn that increasing or decreasing the looseness and/or free play of the flexible jacket by moving a visual stripe located on the flexible jacket, near a tail end of the flexible jacket, with respect to the base cover one, two, or three equally spaced visual stripes located on the base cover provides the needed adjustment. Without the use of the disclosed combination of means for visual alignment, the pressman may find that the adjustment process requires multiple trials and tests to achieve proper adjustment of the flexible jacket, accompanied by a corresponding loss of press productivity. Additionally, the learning process for learning how to adjust the flexible jacket may be less certain and more time consuming. The use of the means for visual alignment on the base cover in combination with the means for visual alignment on the flexible jacket may promote the explicit gauging of adjustments.

In an embodiment, a plurality of means for visual alignment may be disposed horizontally on the base cover. As used herein, horizontal indicates that the means for visual alignment on the base cover are substantially parallel to the axis of the transfer cylinder when the base cover is installed over the transfer cylinder. In an embodiment, the means for visual alignment on the base cover are set off from each other at substantially equal distances, the substantially equal distance in the range from about ¼ inch (about 0.6 cm) to about 1 inch (about 2.5 cm), for example by about ¾ inch (about 1.9 cm). In other embodiments, however, the means for visual alignment on the base cover may be set off from each other at equal distances but different from the range from about ¼ inch to about 1 inch. In an embodiment, a plurality of means for visual alignment may be disposed horizontally on the flexible jacket. As used herein, horizontal indicates that the means for visual alignment on the flexible jacket are substantially parallel to the axis of the transfer cylinder when the flexible jacket is installed over the transfer cylinder. In an embodiment, the means for visual alignment on the flexible jacket are set off from each other at substantially equal distances, the substantially equal distance in the range from about ¼ inch (about 0.6 cm) to about 1 inch (about 2.5 cm), for example by about ¾ inch (about 1.9 cm). In other embodiments, however, the means for visual alignment on the flexible jacket may be set off from each other at equal distances but different from the range from about ¼ inch to about 1 inch. In some embodiments, the means for visual alignment may be offset by about the same amount for both the base cover and the flexible jacket. In another embodiment, the means for visual alignment may be offset by different amounts for the base cover and the flexible jacket. The means for visual alignment, of both and/or either of the base cover and the flexible jacket, may be continuous or interrupted. The means for visual alignment may extend horizontally substantially across the whole of the base cover and/or flexible jacket. Alternatively, the means for visual alignment may extend only partially horizontally across the base cover and/or flexible jacket.

The means for visual alignment on the base cover may be referred to as visual stripes. The visual stripes on the base cover may be applied as a line segment or a series of line segments (e.g., a dotted line) on the base cover, for example by painting, by lithography, by silk screening, by laser induced marking or scoring, to positively define visual stripes horizontally disposed on the base cover. In another embodiment, different colored threads may be employed to positively define visual stripes horizontally disposed on the base cover. For example, the visual stripes may be defined by periodically weaving in one or more threads having a color that contrasts with the color of the majority of threads making up the woven material of the base cover. In another embodiment, the visual stripes may be defined by periodically weaving in one or more threads having a different diameter than the majority of threads making up the woven material of the base cover. In another embodiment, the base cover may be woven in a lattice pattern that creates substantially horizontal visual stripes in the base cover fabric, for example a herringbone pattern, a checkerboard pattern, a basket weave pattern, and other lattice patterns. As used herein, the term fabric may refer to a woven material constructed of natural fibers and/or synthetic fibers.

Alternatively, the visual stripes on the base cover may be provided by omitting one or more threads from the woven material of the base cover, for example by omitting one or more weft threads or by omitting one or more warp threads from a woven base cover. Removing one or more threads from a woven base cover may be said to negatively define visual stripes. The absence of threads from the woven base cover may be discerned by a print operator by seeing a greater portion of the underlying transfer cylinder through the base cover at the location of the missing threads, for example when the transfer cylinder is a bright metal material such as stainless steel. In some embodiments, a backing strip or backing sheet may be adhered to one side of the base cover to promote discernment by a print operator of the visual stripes. Alternatively, a packing sheet that promotes discernment of the visual stripes may be placed around the transfer cylinder beneath the base cover. The backing strips, backing sheet, and/or packing sheet may have a yellow color, an orange color, a red color, or other color which can be more readily discerned through the negatively defined visual stripe. The backing strips, backing sheet, and/or packing sheet may be a shiny, metallic material. In an embodiment, the transfer cylinder may be painted a color that promotes discernment of the visual stripes by a print operator.

Likewise, the means for visual alignment on the flexible jacket may be provided as for the base cover. The means for visual alignment on the flexible jacket may be referred to as visual stripes. The visual stripes on the flexible jacket may be applied as a line segment or a series of line segments (e.g., a dotted line) on the flexible jacket, for example by painting, by lithography, by silk screening, by laser induced marking or scoring, to positively define visual stripes horizontally disposed on the flexible jacket. In another embodiment, different colored threads may be employed to positively define visual stripes horizontally disposed on the flexible jacket. In another embodiment, the base cover may be woven in a lattice pattern that creates substantially horizontal visual stripes in the base cover woven material, for example a herringbone pattern, a checkerboard pattern, a basket weave pattern, and other lattice patterns.

Alternatively, the visual stripes on the flexible jacket may be provided by omitting one or more threads from the woven material of the flexible jacket, for example by omitting one or more weft threads or by omitting one or more warp threads from a woven flexible jacket. Removing one or more threads from a woven flexible jacket may be said to negatively define visual stripes. The absence of threads from the woven flexible jacket may be discerned by a print operator by seeing the base cover through the flexible jacket, for example by seeing a visible stripe on the base cover through the flexible jacket at the area of the missing thread.

The thickness of the visual stripes on the base cover and on the flexible jacket may be different to promote the use of the visual stripes for adjusting the free play of the flexible jacket. As used herein, the term “thickness of the visual stripes” is meant to refer to one of the two dimensions of the visual appearance of visual stripes (the other dimension being the length of the visual stripes) rather than the three dimensional height of the visual stripes above a plane defined by the base cover or flexible jacket when laid out smooth on a flat surface. For example, in an embodiment, the visual stripe of the flexible jacket may be thicker than the visual stripe of the base cover, for example when the visual stripe of the flexible jacket is negatively defined by one or more missing threads in the woven material of the flexible jacket. In another embodiment, the visual stripe of the flexible jacket may be narrower than the visible stripe of the base cover, for example when the visual stripe of the flexible jacket is positively defined by a painting process, a lithographic process, a silk screen process, and/or a laser induced marking or scoring process. The relative thickness and thinness of the visible lines on the base cover and on the flexible jacket may be varied, under different circumstances, to promote ease of alignment and adjustment of the flexible jacket.

In an embodiment, the base cover may be a woven fiberglass material. In other embodiments, however, other materials such as woven cotton material, woven wool material, woven hemp material, woven linen material, woven silk material, woven synthetic fiber material, and other fabric materials may be employed to form the base cover. In an embodiment, the base cover may be painted onto the transfer cylinder. In an embodiment, the base cover may be applied to the transfer cylinder as a coating. In an embodiment, the base cover may be installed over the transfer cylinder and then cured to shrink to fit securely over the transfer cylinder.

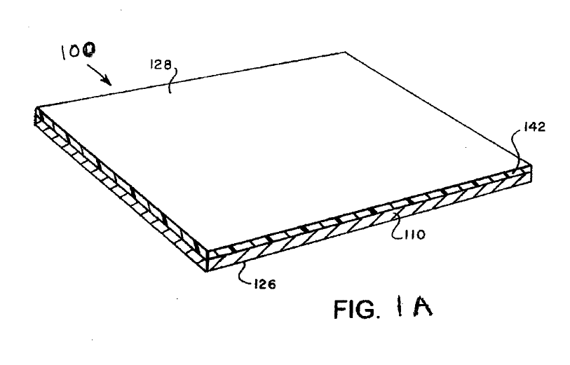

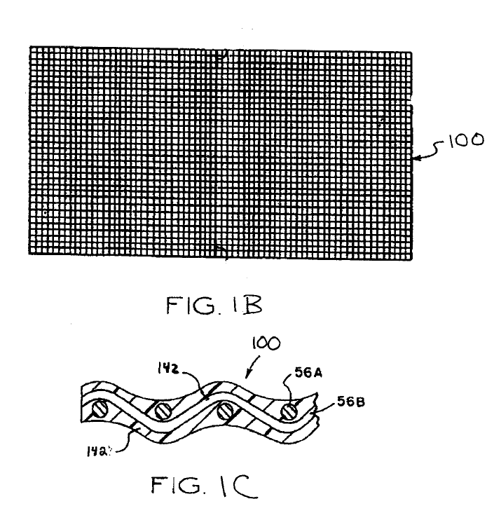

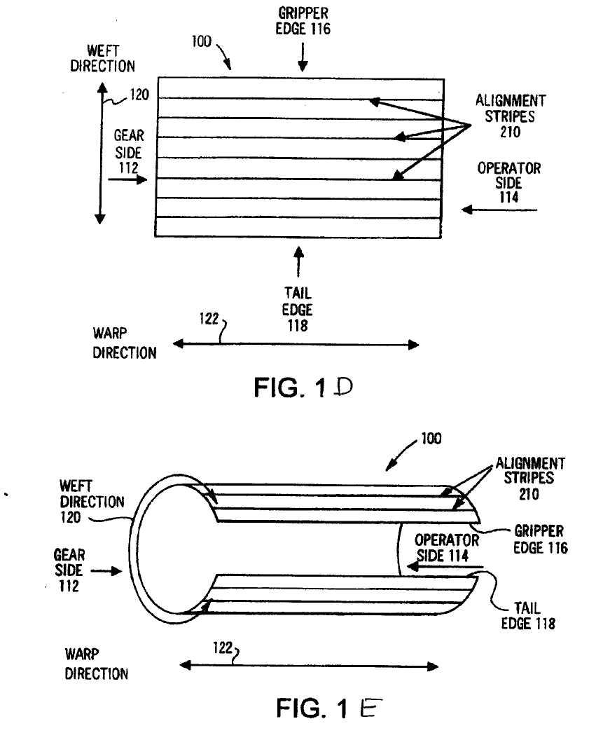

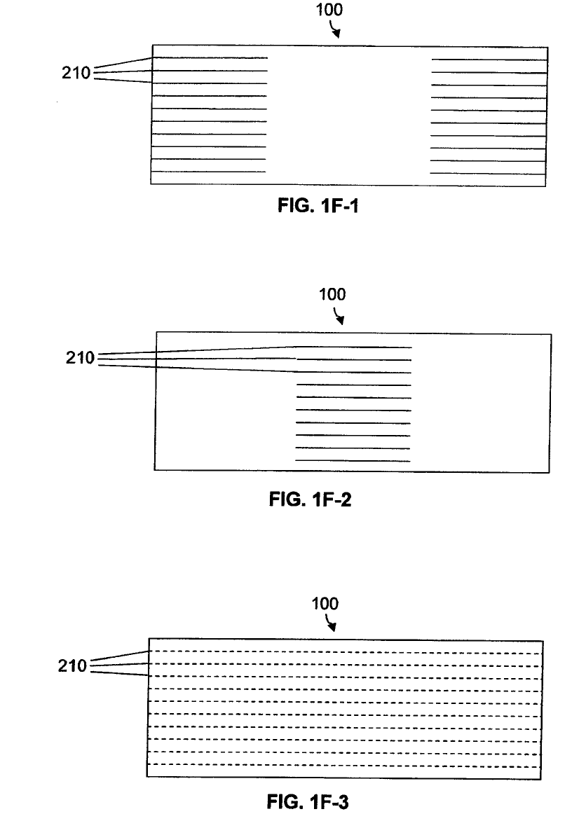

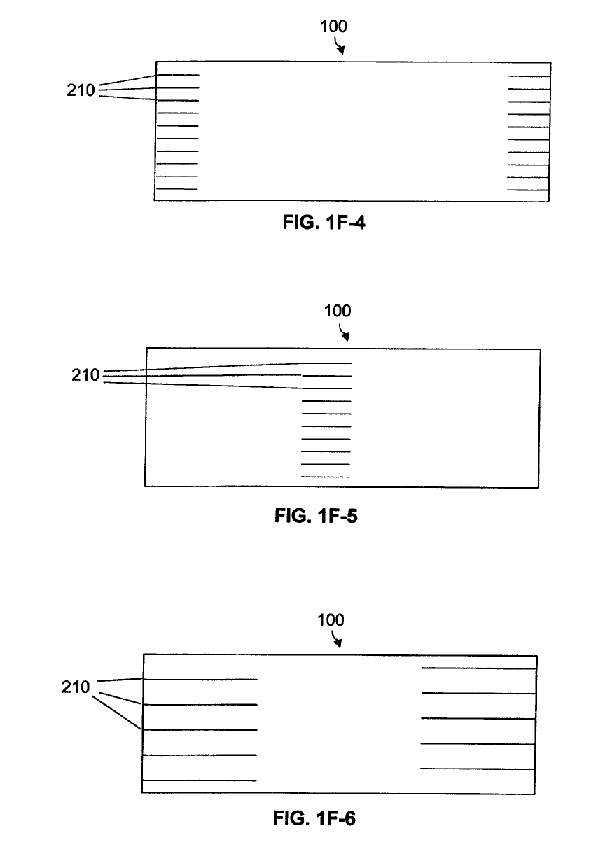

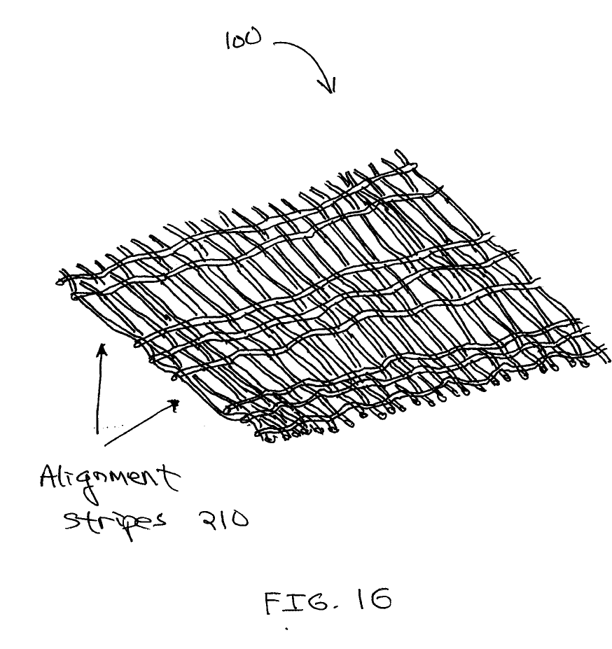

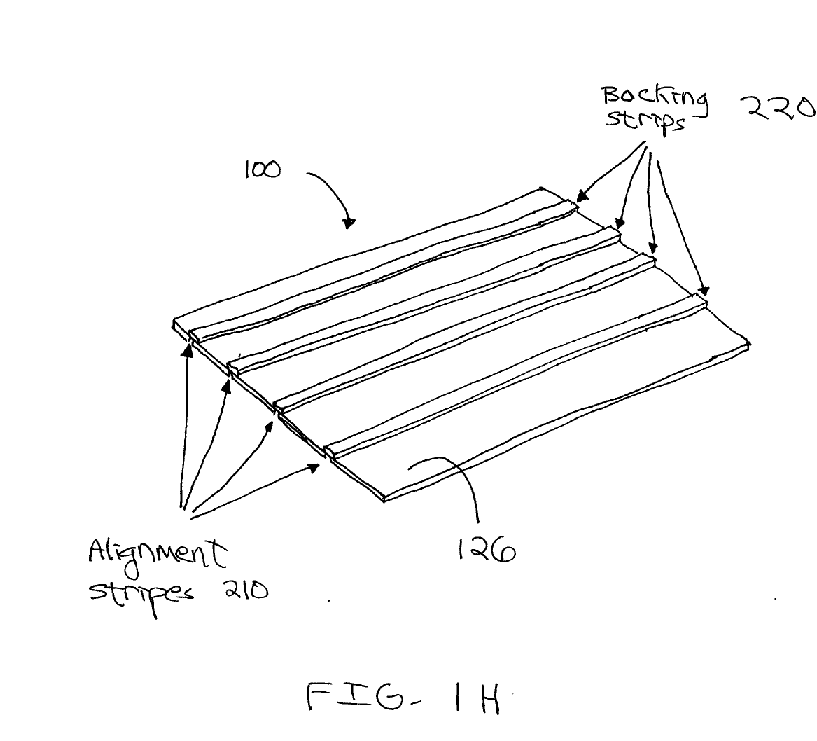

Turning now to FIG. 1A, an embodiment of a base cover 100 is described. The base cover 100 has a cover bottom surface 126 for contact with a transfer cylinder and a cover top surface 128. In an embodiment, the base cover 100 comprises a base layer 110 (also referred to herein as a carrier sheet) and one or more additional top layers 142, which may be films or coatings, for example conductive compounds. In some embodiments, the cover top surface 128 is a low friction surface. An exemplary top layer may comprise a coating of a fluoropolymer such as fluorinated ethylene propylene (FEP) resin or a polytetrafluoroethylene (PTFE) resin, for example sold under the trademarks TEFLON available from DuPont Corporation and XYLAN available from Whitford Corporation. In an embodiment, the fluoropolymer resin further comprises a conductive material such as carbon black, graphite, or the like. The low friction top surface 128 may be smooth, or alternatively may be rough or textured to further reduce the area in contact with the flexible jacket covering. Preferably, the low friction cover top surface 128 has frictional coefficient that is less than the frictional coefficient of the bare transfer cylinder support surface. The frictional coefficient may be further reduced by radially projecting surface portions on the cover top surface 128. The radially projecting surface portions may be provided by weft and/or warp strands of woven materials, nodes, beads, and combinations thereof.

The base layer 110 may comprise natural material such as cotton, hemp, wool, silk, linen, and the like and/or a synthetic material, including cellulosic fiber such as rayon; linear polyamides such as nylon; linear polyesters such as polyethylene terephthlate sold under the trade name MYLAR; hydrocarbon or halogenated hydrocarbon resins such as polyethylene, polypropylene or ethylene-propylene copolymers; aramid and polyaramids such as those sold under the trade names KEVLAR and NOMEX; and acrylonitrile butadinene styrene (ABS). In an embodiment, the base layer 110 may comprise a web of fiberglass. These base layer materials may be sheets, films, webs (both woven and non-woven) and the like, preferably have a low coefficient of friction surface, and may be combined with a conductive agent, such as carbon black, graphite or the like, to render the base layer material at least partially conductive and/or semi-conductive. In an embodiment, the top layer 142 of the base cover 100 may have a resistivity at room temperature (about 70 degrees Fahrenheit) in the range from about 10⁻² ohms/centimeter to about 10⁹ ohms/centimeter. These base layer materials may optionally be used in combination with one or more additional layers (i.e., top layer 142), for example a layer or coating of PTFE.

Referring now to FIG. 1B and FIG. 1C, in an embodiment the base layer 110 is a fabric (comprising natural fibers, synthetic fibers, or both), such as a woven material having warp strands 56A and weft strands 56B, and a top layer 142 that comprises a coating of a conductive compound such as FEP or PTFE resin. The warp and weft (fill) strands may comprise fiberglass, polyamide, or both, woven together in a base fiber thickness of about 0.007 inch (0.2 mm). The woven material may be coated with conductive PTFE resin to a finished thickness in the range of about 0.004 to 0.020 inches (0.1 to 0.5 mm), a finished weight in the range of 17-20 ounces per square yard, with a tensile strength of approximately 400 pounds per square inch in the warp and approximately 250 pounds per square inch in the weft.

In an embodiment, the base cover 100 is a laminate of the base layer 110 comprising MYLAR and bonded thereto a top layer 142 comprising PTFE and carbon black, such laminates are sold under the trade name CHEMLAM RLPR400 available from St. Gobain Corporation.

As used herein, “fluoropolymer” means and refers to fluorocarbon polymers, for example polytetrafluoroethylene, polymers of chlorotrifluoroethylene, fluorinated ethylene-propylene polymers, polyvinylidene fluoride, hexafluoropropylene, and other elastomeric high polymers containing fluorene, also known and referred to as fluoroelastomers. The fluoropolymer resins preferably contain electrically conductive carbon black, or some other conductive agent such as graphite or the like, preferably in an amount sufficient to provide a relatively low surface resistivity. The coefficient of friction and conductivity of the base cover 100 are influenced by the amount of the conductive agent present in the conductive compound. Consequently, the amount of conductive agent included in the fluoropolymer resin for a given conductivity or surface resistivity will necessarily involve a compromise with the coefficient of friction. Generally, high conductivity (low surface resistivity) and low coefficient of friction are desired.

In another embodiment, the base layer 110 comprises a metal foil carrier sheet, constructed of a malleable metal such as aluminum, copper, zinc or the like. The surface of the conductive carrier sheet may be covered by the top layer 142 that comprises a fluoropolymer resin that contains a conductive agent, for example polytetrafluoroethylene resin (PTFE) containing carbon black, as previously specified.

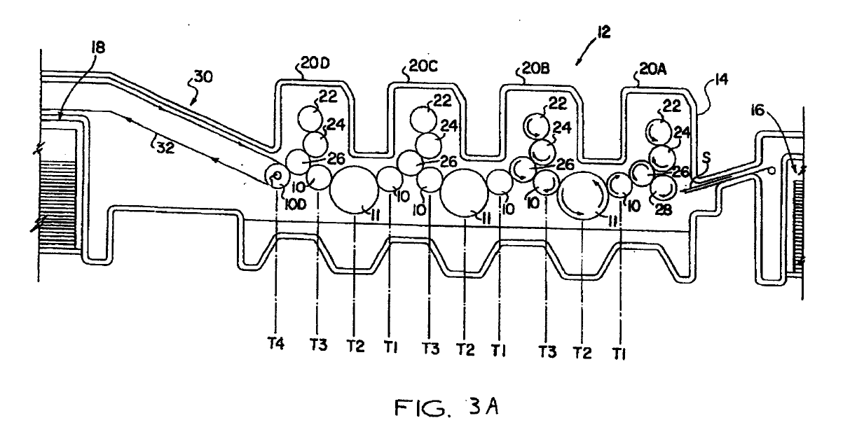

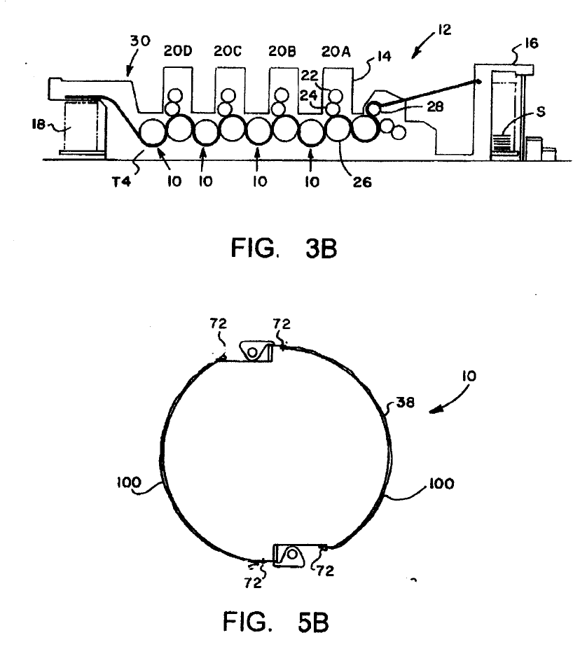

Referring now to FIG. 1D, the base cover 100 comprises a sheet of material that is substantially flat. The base cover 100 has a cover gear side 112 and a cover operator side 114. When installed on a transfer cylinder, the cover gear side 112 is located towards the gear side of a press while the cover operator side 114 is located towards the operator side of the press. The base cover 100 further has a cover gripper edge 116 and a cover tail edge 118. When installed on a transfer cylinder, the cover gripper edge 116 is located towards the gripper edge of the transfer cylinder while the cover tail edge 118 is located towards the tail edge of the transfer cylinder. One skilled in the art will be familiar with these orientation terms, but they will be discussed more particularly with reference to FIG. 3A and FIG. 3B below when an exemplary press is discussed.

In an embodiment, the base cover 100 is characterized by at least one means for visual alignment. As depicted in FIG. 1D, the means for visual alignment may comprise a plurality of base cover alignment stripes 210. In another embodiment, however, the means for visual alignment may comprise one or a small number of base cover alignment stripes 210. In an embodiment, the means for visual alignment may be located at only one end of the base cover 100, for example only at the cover tail edge 118. In some contexts, the base cover alignment stripes 210 may be referred to as visual stripes. The base cover alignment stripes 210 may be disposed at substantially equal distances from each other. In an embodiment, the base cover alignment stripes 210 may be separated by a distance in the range from about ¼ inch (about 0.6 cm) to about 1 inch (about 2.5 cm). In an embodiment, the base cover alignment stripes 210 may be separated by a distance of about ¾ inch (about 1.9 cm). One skilled in the art, in combination with the present disclosure, may readily select a preferred separation of base cover alignment stripes 210.

The base cover alignment stripes 210 may be applied on the base cover 100, for example by painting process, a silk-screen process, by a lithographic process, or by another process. The thickness and/or width of the base cover alignment stripes 210 may be controlled to promote ease of alignment and/or adjustment of the flexible jacket 300. The color of the base cover alignment stripes 210, when painted on the base cover 100, may be selected to provide a contrast with the color of the base cover 100. The base cover alignment stripes 210 may be adhered to the base cover 100. The base cover alignment stripes 210 may be provided by differently colored threads woven into the base layer 110. The base cover alignment stripes 210 may be provided by a lattice pattern or other weave pattern woven into the woven material of the base cover 100, for example a checkerboard pattern, a basket weave pattern, or a herringbone pattern. The base cover alignment stripes 210 may be defined negatively by omission of one or more threads from a woven material matrix, for example by omission of one or more warp threads or by omission of one or more weft threads from a woven fabric comprising warp and weft threads. In an embodiment, the base cover 100 may be woven with a weft direction 120 and a warp direction 122 as illustrated in FIG. 1D. In another embodiment, the weft and warp direction of the base cover 100 may be interchanged.

Turning now to FIG. 1E, the base cover 100 is shown as it may be installed over a transfer cylinder. In an embodiment, the base cover 100 is a substantially flat, flexible material that may be wrapped around the transfer cylinder, with the base cover alignment stripes 210 disposed longitudinally across the base cover 100. While the base cover alignment stripes 210 are illustrated in FIG. 1D and in FIG. 1E as extending horizontally substantially from the gear side 112 to the operator side 114, in another embodiment the base cover alignment stripes 210 may not extend from edge to edge of the base cover 100 but may extend only partially across the base cover 100, for example only about half way across the base cover 100, only about one third way across the base cover 100, or some other partial extension across the base cover 100.

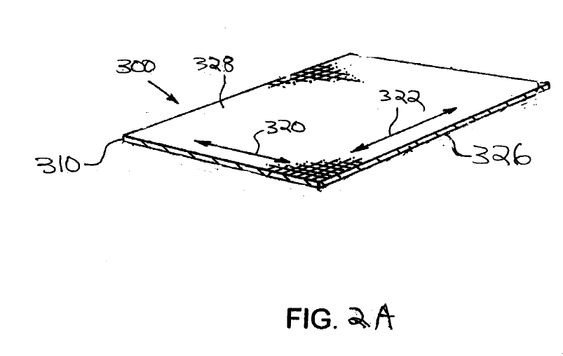

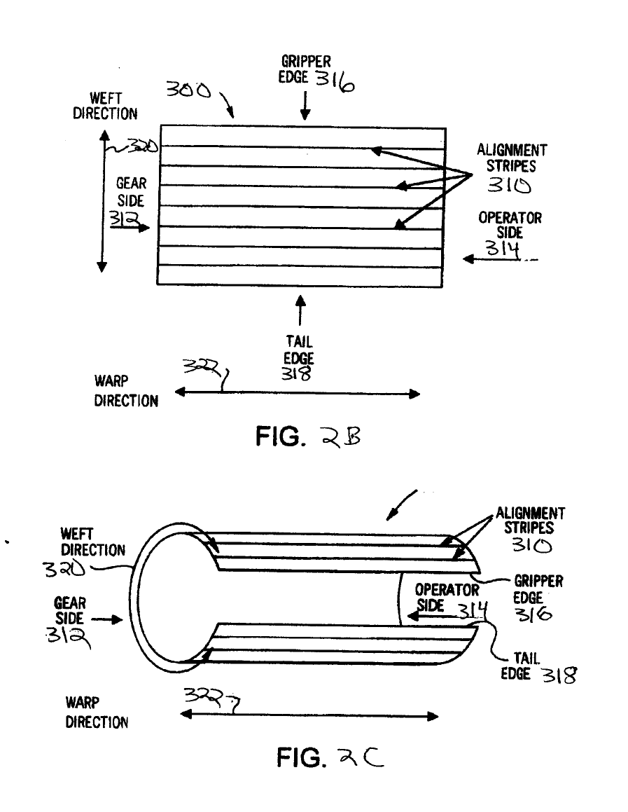

Turning now to FIG. 1F-1, FIG. 1F-2, FIG. 1F-3, FIG. 1F-4, FIG. 1F-5, and FIG. 1F-6, a plurality of alternative embodiments of the base cover alignment stripes 210 are disclosed. A variety of base cover alignment stripes 210 are contemplated by the present disclosure. As illustrated in FIG. 1F-1, the base cover alignment stripes 210 may extend horizontally from near the operator side 114 to the interior of the base cover 100 and from near the gear side 112 to the interior of the base cover 100 while the middle region of the base cover 100 does not contain the base cover alignment stripes 210. In an alternative embodiment, the spacing between the base cover alignment stripes 210 proximate to the operator side 114 may feature a first spacing distance while the spacing between the base cover alignment stripes 210 proximate to the gear side 112 may feature a second spacing distance, where the first spacing distance is different from the second spacing distance. While illustrated in FIG. 1F-1 as about one third the width of the base cover 100, in some embodiments the width of the alignment stripes 210 may be either less than or greater than one third the width of the base cover 100. While the base cover alignment stripes are illustrated in FIG. 1F-1 as originating at the edges of the base cover 100 and extending inwards, in an embodiment the base cover alignment stripes may originate from a point slightly in from the edge of the base cover 100, for example about one inch to about four inches in from the edge of the base cover 100. As illustrated in FIG. 1F-2, the base cover alignment stripes 210 may extend horizontally across the middle region of the base cover 100 but not extend out to the edges. As illustrated in FIG. 1F-3, the base cover alignment stripes 210 may be dashed. Alternatively, in some embodiments, the base cover alignment stripes 210 may be discontinuous having a different pattern of blank spaces, line segments, dots, and other shapes. As illustrated in FIG. 1F-4 the base cover alignment stripes 210 may comprise relatively short line segments located near the operator side 114 and the gear side 112 of the base cover 100 and missing from the main portion of the base cover 100. In an alternative embodiment, the spacing between the base cover alignment stripes 210 proximate to the operator side 114 may feature a first spacing distance while the spacing between the base cover alignment stripes 210 proximate to the gear side 112 may feature a second spacing distance, where the first spacing distance is different from the second spacing distance. As illustrated in FIG. 1F-5, the base cover alignment stripes 210 may comprise relatively short line segments located near the center of the base cover 100. As illustrated in FIG. 1F-6, the base cover alignment stripes may comprise segments on both the operator edge and the gear edge of the base cover 100, where the line segments on opposite edges are offset with respect to each other. One skilled in the art will readily appreciate that other alternative dispositions of the base cover alignment stripes 210 and combinations of the above dispositions are suggested by the above illustrations, all of which are contemplated by the present disclosure.

Turning now to FIG. 1G, the base cover 100 is illustrated as a woven fabric wherein the base cover alignment stripes 210 are negatively defined by omitted threads in the horizontal direction. In combination with the present disclosure, one skilled in the art may readily determine how many threads to omit to provide the benefit of a visual alignment stripe for the base cover 100. Turning now to FIG. 1H, the base cover 100 is illustrated wherein the base cover alignment stripes 210 are negatively defined by omitted threads in the horizontal direction and wherein the base cover alignment stripes 210 are backed up on the cover bottom surface 126 of the base cover 100 by a plurality of backing strips 220. In an embodiment, rather than a plurality of backing strips 220, the base cover 100 may comprise a backing adhered to or attached to the cover bottom surface 126. Alternatively, a packing sheet that promotes discernment of the base cover alignment stripes 210 may be placed around the transfer cylinder beneath the base cover 100. As described above, the backing or packing may have a yellow color, an orange color, a red color, or other color which can be more readily discerned through the omitted threads. The backing or packing may also include a shiny, metallic surface. In an embodiment, the transfer cylinder may be painted a color that promotes discernment of the base cover alignment stripes 210 by a print operator.

The embodiments of the base cover 100 discussed above are exemplary, and other alternative configurations will be readily apparent to those skilled in the art based upon the description herein. Other embodiments of base covers are disclosed in U.S. Pat. Nos. 5,511,480; 5,603,264; 6,073,556; and 6,192,800, referenced previously and owned by Printing Research Inc. of Dallas, Tex., U.S.A. The previously described embodiments of the base cover are each effective for reducing the amount of surface area contact with the flexible jacket covering. For example, the overlapping warp and weft (fill) strands 56A, 56B of the woven embodiment (FIG. 1B and FIG. 1C) provide a lattice-like framework of radially projecting portions that reduce the surface area contact for frictional engagement by a flexible jacket.

In an embodiment, the base cover 100 may be manufactured in a one-step process, wherein the base layer 110 is woven so as to periodically omit one of either one or more of a weft thread or one or more of a warp thread from a continuous sheet of woven material. For example, the process may omit one or more weft threads every about ¾ inch (about 1.9 cm). As another example, the process may omit one or more warp threads every about ¾ inch (about 1.9 cm). Other spacings between omitted threads may be employed. The process may further include cutting the continuous sheet of woven material into separate sheets sized appropriately to form the base layer 110 of the base cover 100. The process may also include coating the woven material with a material, for example a low friction coating and/or an anti-static conductive coating. The coating may be applied to the woven material while it is in the continuous sheet form or may be applied to the separately cut sheets of base layers 110. In an embodiment, the process may include adhering backing strips 220 to woven fabric, for example aligned with the base cover alignment stripes 210, as illustrated in FIG. 1H. The backing strips 220 may be applied while the woven material is in the continuous sheet form or after the base layers 110 have been formed by cutting the continuous woven material into individual sheets. In an embodiment, the process may include adhering a backing sheet to the base layers 110 or to the continuous woven material.

Turning now to FIG. 2A, FIG. 2B, and FIG. 2C an embodiment of a flexible jacket 300 is described. In some contexts, the flexible jacket 300 may be referred to as a net. The flexible jacket 300 has a jacket bottom surface 326 and a jacket top surface 328. When installed over the base cover 100 and/or the transfer cylinder, the jacket bottom surface 326 may be in at least partial contact with the cover top surface 128. When in use, the jacket top surface 328 may be in contract with a processed substrate. The flexible jacket 300 has a jacket gear side 312 and a jacket operator side 314. When installed over the base cover 100 and/or the transfer cylinder, the jacket gear side 312 is located towards the gear side of a press while the jacket operator side 314 is located towards the operator side of the press. Arrow 320 indicates the weft direction (also referred to as the transverse or fill direction) of the flexible jacket 300, and arrow 322 indicates the warp direction (also referred to as the machine direction) of the flexible jacket 300.

The flexible jacket 300 may be made from any material suitable for providing effective, anti-marking support and transfer of processed substrates during printing operations. The flexible jacket 300 may comprise a woven material, for example a natural material such as cotton, hemp, wool, silk, linen, and the like or a synthetic material such as nylon, rayon, polyesters, polyacrylates, polyolefins, polyimides, polyamides, and the like. A preferred fabric is a loosely woven, lightweight cotton material such as gauze or cheesecloth having about a forty mesh and weave of about 28 warp×32 weft (fill). The flexible jacket 300 may be treated with fabric softeners, fabric protectors, anti-static compounds, and the like to help reduce ink buildup thereon. A preferred fabric treatment is Scotchguard available from 3M Corporation. In an embodiment, the flexible Jacket 300 is conductive and/or semiconductive. As used herein, the term conductive means that the material is capable of dissipating an electrostatic charge through contact with a grounded object, for example passing electrostatic charges from the printed substrate to the cylinder base cover and/or the transfer cylinder to a grounded press frame. The electrical resistivity of a preferred material at room temperature (70° F.; 21° C.) is in the range 10⁻² ohms/centimeter to 10⁹ ohms/centimeter, which is between the resistivity of metals and insulators. The flexible jacket 300 may be made conductive and/or semiconductive, for example, by treatment with a conductive means or by weaving one or more conductive and/or semiconductive strands or threads spaced in the weft and/or warp directions.

In one embodiment, conductivity of the strands or threads in the flexible jacket 300 is obtained by impregnating or otherwise treating the strands or threads with an aqueous solution of an anti-static ionic polymer compound selected from the group including ammonium salts, polyglycerol esters and sorbitan esters That is, the flexible jacket 300 is treated by soaking in an aqueous solution of an anti-static ionic polymer compound, or by spraying the aqueous solution of anti-static ionic polymer compound onto the flexible jacket 300, or by impregnating the threads or strands with the aqueous anti-static ionic compound prior to weaving. In another embodiment, the strands are rendered conductive by applying a conductive fluropolymer resin coating on each strand. In another embodiment, the flexible jacket 300 can be constructed entirely of natural threads, strands or fibers, and can be rendered conductive by impregnating the woven material with an ionic polymer selected from the group including polyacrylic acid polymers and polyammonium polymers. In another embodiment, the flexible jacket 300 can be rendered conductive by forming at least one or more of the strands of a conductive material, for example a metal wire such as a bare copper filament or other metal filament. As previously discussed, the conductive elements of the flexible jacket 300 are preferably uniformly distributed throughout the body of the flexible jacket 300.

In an embodiment, the fabric material composing the flexible jacket 300 is selected to have the property of substantially resisting elongation in response to a tension force applied to the flexible jacket 300 by smoothing hand pressure with its elastic recovery being less than about two percent (2%) of its relaxed length in response to tension induced by light, smoothing hand pressure applied to the jacket covering. Preferably, the flexible fabric material has an ASTM Strength and Elongation rating (for a one inch by six inch sample) that does not exceed about six percent (6%) in weft elongation, with breakage occurring in weft at about seven percent (7%) elongation, and does not exceed about eleven percent (11%) in warp elongation, with breakage occurring in warp at about twelve percent (12%) elongation.

In an embodiment, the flexible jacket 300 comprises visual means for aligning the flexible jacket 300 for attachment to the transfer cylinder, over the base cover 100. Referring to FIG. 2B, the flexible jacket 300 may include one or more flexible jacket alignment stripes 310 horizontally disposed on the flexible jacket 300 for easily and precisely securing the flexible jacket 300 over and in alignment with the gripper edge and the tail edge of a transfer cylinder. Hereinafter, the flexible jacket alignment stripes 310 are referred to as jacket alignment stripes 310. The jacket alignment stripes 310 may be provided in a number of alternative fashions, for example in similar fashion to the base cover alignment stripes 210 illustrated in FIG. 1F-1,2,3,4,5,6. The combination of visual alignment means on the base cover 100 and visual alignment means on the flexible jacket 300 may provide for ease and repeatability of adjustment and may reduce learning time for new press operators. The jacket alignment stripes 310 may be provided by different colored threads woven into the flexible jacket 300. In an embodiment, the jacket alignment stripes 310 may be applied onto the flexible jacket 300 by a painting process or a silk screen process or a lithographic process or a laser induced marking or scoring process. In an embodiment, the jacket alignment stripes 310 may be provided by a weaving pattern, for example a herringbone pattern, that defines substantially horizontal visual stripes in the flexible jacket 300. In an embodiment, the jacket alignment stripes 310 may be provided by missing threads in the woven fabric composing the flexible jacket 300. The thickness and/or width of the jacket alignment stripes 310 may be varied to promote ease of alignment and/or adjustment of the flexible jacket 300 in combination with the base cover alignment stripes 210.

While illustrated in FIG. 2B and FIG. 2C as a plurality of jacket alignment stripes 310 that extend horizontally from the flexible jacket gear side 312 to the flexible jacket operator side 314 of the flexible jacket 300, in other embodiments different dispositions of the means for visual alignment are contemplated. In an embodiment, the means for visual alignment may extend only partially across the flexible jacket 300, for example about half way across or about one third way across the flexible jacket 300. In an embodiment, the means for visual alignment is not located all the way around the flexible jacket 300 from the flexible jacket gripper edge 316 to the jacket tail edge but instead may be located only at one or the other edge, for example preferably at the flexible jacket tail edge 318. In an embodiment, the jacket alignment stripes 310 may be disposed about equal distance apart in the range from about ¼ inch (0.6 cm) apart to about 1 inch (2.5 cm) apart. In an embodiment, the jacket alignment stripes 310 are spaced about ¾ inch (1.9 cm) apart. In some embodiments, the base cover alignment stripes 210 and the jacket alignment stripes 310 are spaced about the same distance apart. In another embodiment, however, an advantage may be obtained by employing a different spacing for the base cover alignment stripes 210 versus the spacing employed for the jacket alignment stripes 310. For example, in a first case the free play of the flexible jacket 300 may be adjusted based on a first spacing of the jacket alignment stripes 310 while in a second case the free play of the flexible jacket 300 may be adjusted based on a second spacing of the base cover alignment stripes 210.

Other embodiments of flexible jackets useful in practicing the present invention are disclosed in U.S. Pat. Nos. 5,907,998; 5,979,322; 6,119,597; and 6,244,178, referenced previously and owned by Printing Research Inc. of Dallas, Tex., U.S.A.

For exemplary purposes, the base cover 100 and the flexible jacket 300 will be described with reference to the processing of sheet substrates. However, it will be understood that the principles of the disclosure are equally applicable to web substrates. The base cover with means for visual alignment and the flexible jacket with means for visual alignment of the present disclosure may be used in combination with high-speed printing press equipment of the type used, for example, in offset printing. FIG. 3A shows a typical, four color offset printing press of the type made by Heidelberg Druckmaschinen Aktiengesellschaft, and FIG. 3B shows a four color offset printing press of the Lithrone Series available from Komori Corp. Referring to FIGS. 3A and 3B, such equipment includes one or more transfer cylinders 10 for handling a processed substrate such as a freshly printed sheet between printing units and upon delivery of the printed sheet to a delivery stacker. The base cover 100 and the flexible jacket 300 of the present disclosure are installed on transfer cylinders 10. As used herein, the term “processed” refers to various printing methods, which may be applied to either side or both sides of a substrate, including the application of aqueous inks, protective coatings and decorative coatings. The term “substrate” refers to sheet material or web material.

Use of the present disclosure in combination with the transfer cylinder 10 at an interstation transfer position (T1, T3) or at a delivery position (T4) in a typical rotary offset printing press 12 is believed to be readily understandable to those skilled in the art. In any case, reference may be made to my earlier U.S. Pat. Nos. 3,791,644 and 4,402,267, which disclose details regarding the location and function of a sheet support cylinder in a typical multistation printing press. The present disclosure may, of course, be utilized with conventional printing presses having any number of printing units or stations.

Referring to FIGS. 3A and 3B, the press 12 includes a press frame 14 coupled on its input end to a sheet feeder 16 from which sheets, herein designated S, are individually and sequentially fed into the press. At its delivery end, the press 12 is coupled to a sheet stacker 18 in which the printed sheets are collected and stacked. Interposed between the sheet feeder 16 and the sheet stacker 18 are four substantially identical sheet printing units 20A, 20B, 20C, and 20D which are capable of printing different color inks onto the sheets as they are transferred through the press.

As illustrated in FIGS. 3A & 3B, each printing unit is of conventional design, and includes a plate cylinder 22, a blanket cylinder 24 and an impression cylinder 26. Freshly printed sheets S from the impression cylinder are transferred to the next printing unit by a transfer cylinder 10. The initial printing unit 20A is equipped with a sheet in-feed roller 28 which feeds individual sheets one at a time from the sheet feeder 16 to the initial impression cylinder 26. In an embodiment, the transfer cylinder may be painted a color that promotes discernment of the base cover alignment stripes 210 by a print operator.

The freshly printed sheets S are transferred to the sheet stacker 18 by a delivery conveyor system, generally designated 30. The delivery conveyor 30 is of conventional design and includes a pair of endless delivery gripper chains 32 carrying transversely disposed gripper bars, each having gripper elements for gripping the leading edge of a freshly printed sheet S as it leaves the impression cylinder 26 at the delivery position T4. As the leading edge of the printed sheet S is gripped by the grippers, the delivery chains 32 pull the gripper bars and sheet S away from the impression cylinder 26 and transport the freshly printed sheet S to the sheet delivery stacker 18.

Referring to FIG. 3A, an intermediate transfer cylinder 11 receives sheets printed on one side from the transfer cylinder 10 of the preceding printing unit. Each intermediate transfer cylinder 11, which is of conventional design, typically has a diameter twice that of the transfer cylinder 10, and is located between two transfer cylinders 10, at interstation transfer positions T1, T2 and T3, respectively. The impression cylinders 26, the intermediate transfer cylinders 11, the transfer cylinders 10, as well as the sheet in-feed roller 28, are each provided with sheet grippers which grip the leading edge of the sheet to pull the sheet around the cylinder in the direction as indicated by the associated arrows. The transfer support cylinder 10 in the delivery position T4 is not equipped with grippers, and includes instead a large longitudinal opening A, which provides clearance for passage of the chain driven delivery conveyor gripper bars.

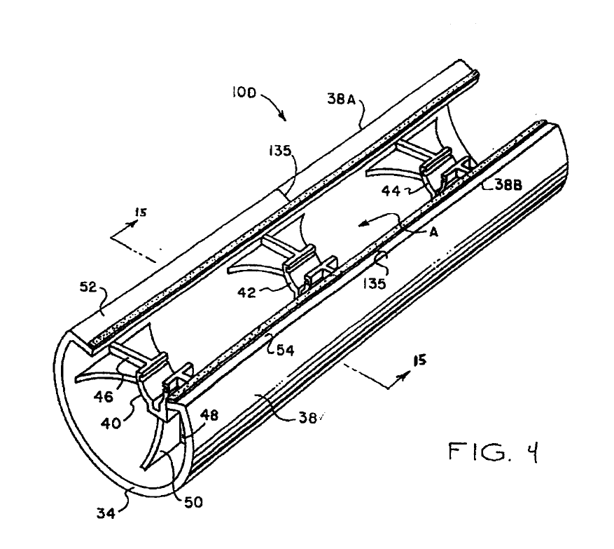

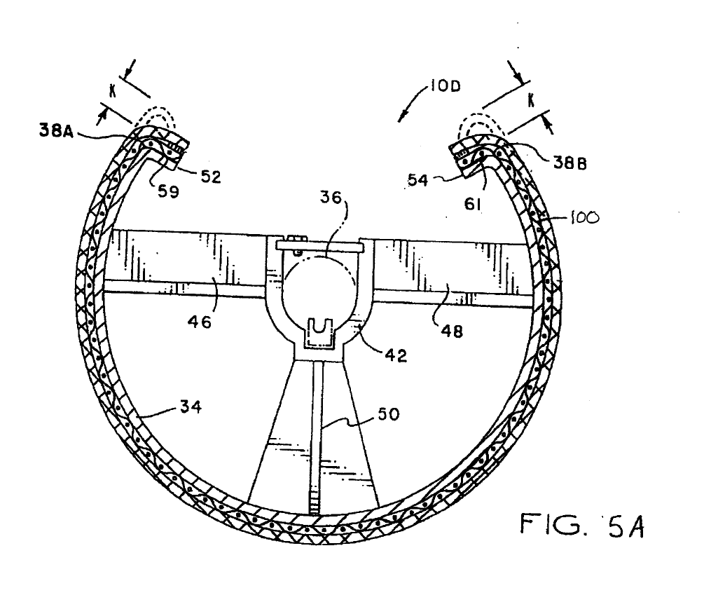

Referring now to FIGS. 4 and 5A, a preferred transfer cylinder is shown for use with the Heidelberg printing press of FIG. 3A. The base cover 100 and the flexible jacket 300 described herein above are installed on a transfer cylinder 10D on the last printing unit 20D of the press 12 in the delivery position (T4) and has a cylindrical rim 34 which is supported for rotation on the press frame 14 by a rotatable delivery shaft 36. The external cylindrical surface 38 of the cylindrical rim 34 has a gap “A” extending longitudinally along the length of the transfer cylinder and circumferentially between gripper edge 38A and tail edge 38B, respectively. The transfer cylinder 10D is attached to the delivery shaft 36 by longitudinally spaced hubs 40, 42 and 44. Additionally, center alignment marks 135 are formed on the cylinder flanges portions 52, 54 and on the external cylindrical surface 38 of the cylindrical rim 34, as shown in FIG. 4. The purpose of the center alignment marks 135 is to facilitate the precise alignment and attachment of the base cover 100 and/or the flexible jacket 300 to the transfer cylinder. In an embodiment, a center alignment mark may also be provided on the base cover 100 and/or the flexible jacket 300. The center alignment mark may be distinguished from the visible stripes at least by the fact that the center alignment mark is substantially perpendicular to the axis of the transfer cylinder while the visible stripes are substantially parallel to the axis of the transfer cylinder.

The hubs 40, 42 and 44 are connected to the cylindrical rim 34 by webs 46, 48 and 50, and support the transfer cylinder 10D for rotation on the delivery shaft 36 of the printing press 12 in a manner similar to the mounting arrangement disclosed in my U.S. Pat. No. 3,791,644. In the embodiment shown in FIG. 4, the delivery cylinder 10D includes opposed cylinder flanges 52, 54, which extend generally inwardly from the surface of the cylindrical rim portion 34. The flanges 52 and 54 include elongated flat surfaces for securing the base cover 100 and the flexible jacket 300 as described below. As described herein, transfer cylinders may have alternative configurations for accommodating the various means for releasably attaching the base cover 100 and the flexible jacket 300 to the transfer cylinder as described herein.

Referring to FIG. 5B, a cross-sectional view of preferred transfer cylinder is shown for use with the Lithrone Series printing press of FIG. 3B. Transfer cylinder 10 is designed and configured to accept a pair of covers, with a first cover covering about one-half of the cylindrical surface 38 of the transfer cylinder and a second cover covering about the remaining one-half of the cylindrical surface 38. The base cover 100 is releasably attached to transfer cylinder 10 at the cover tail edge 118 and the cover gripper edge 116 with flat clamp bar 72 held in place with a series of spring loaded screws spaced along the length of the clamp bar. In some cases, the base cover 100 may remain in service for an extended period of time, for example many years. The flexible jacket 300 is attached by various means including, but not limited to, hook and loop fabric material such as VELCRO that mates adheringly to the flexible jacket 300, double sided tape, and other adhering means. In an embodiment, the flexible jacket 300 may be precision cut to promote simple installation and proper free play without adjustment. In some cases, the flexible jacket 300 may be replaced about every three months, about every six months or on some other interval. The flexible jacket 300 may be replaced at different intervals, and sometimes significantly longer intervals, depending on factors of use including amount and quality of ink employed, amount of printing performed, and other factors.

The function and operation of the transfer cylinders and associated grippers of the printing units are believed to be well known to those familiar with multi-color sheet fed presses, and need not be described further except to note that the impression cylinder 26 functions to press the sheets against the blanket cylinders 24 which applies ink to the sheets, and the transfer cylinders 10 guide the sheets away from the impression cylinders with the wet printed side of each sheet facing against the support surface of the transfer cylinder 10. Since each transfer cylinder 10 supports the printed sheet with the wet printed side facing against the transfer cylinder support surface, the transfer cylinder 10 is provided with the flexible jacket 300 and the base cover 100 an as described herein. The base cover 100 and the flexible jacket 300 are releasably attached to the transfer cylinder by means for releasably attaching the base cover 100 and the flexible jacket 300 to a transfer cylinder. In an embodiment shown in FIG. 5A, the flexible jacket 300 is connected to the transfer cylinder flanges 52 and 54 by the hook and loop (i.e., VELCRO) fastener strips 59, 61. Alternatively, the flexible jacket 300 may be, at least partially, connected to the transfer cylinder using double sided tape or adhesive strip. In an embodiment shown in FIG. 5A, the base cover 100 may be attached to the transfer cylinder flanges 52 and 54 by mechanical mechanisms, for example by mechanical fasteners such as screws; mechanical take up reels or any other forms of mechanical roll up bars (often referred to collectively as reel cylinders); and the like. Upon installation of the base cover 100 and the flexible jacket 300, the flexible jacket 300 is movable relative to the base cover 100 as described previously.

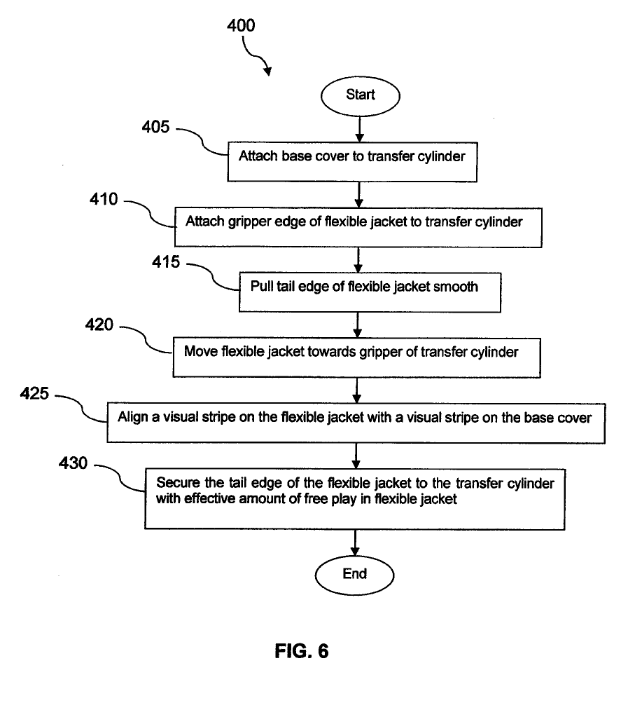

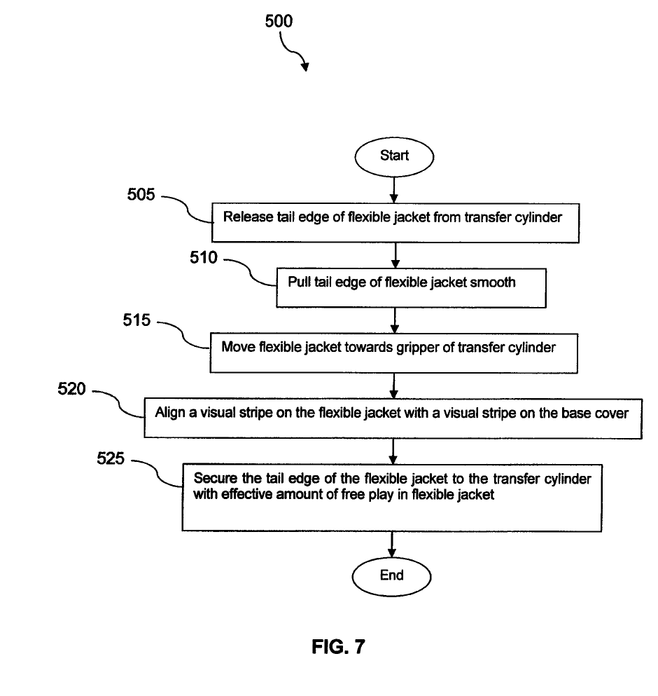

Tuning now to FIG. 6, a method 400 for attaching the flexible jacket 300 over the transfer cylinder 10 is described. At block 405 the base cover 100 is attached to the transfer cylinder 10. The base cover 100 may be attached at both the tail edge 118 and the gripper edge 116 by a variety of mechanical means, for example by a mechanical clamp. The base cover 100, as described above, has at least one horizontally disposed visual stripe and/or means for visual alignment.

At block 410, the gripper edge 316 of the flexible jacket 300 is attached to the transfer cylinder 10. The flexible jacket 300, as described above, has at least one horizontally disposed visual stripe and/or means for visual alignment. At block 415, the tail edge 318 of the flexible jacket 300 is pulled smooth. The press operator may also smooth the flexible jacket 300 over the transfer cylinder 10 during this step.

At block 420, the flexible jacket 300 is moved towards the gripper of the transfer cylinder 10 to provide a desirable amount of free play in the flexible jacket 300. At block 425, a visual stripe on the flexible jacket 300, for example one of the jacket alignment stripes 310, is aligned with a visual stripe on the base cover 100, for example one of the base cover alignment stripes 210. The alignment may be performed visually by a press operator. This step may involve partially seeing the visual stripe on the base cover 100 through the flexible jacket 300. In some embodiments, the base cover alignment stripes 210 may be wider than the jacket alignment stripes 310. Alternatively, in some embodiments, the jacket alignment stripes 310 may be wider than the base cover alignment stripes 210. For example, in an embodiment where the jacket alignment stripes 310 are provided by a missing thread or threads in the woven fabric of the flexible jacket 300, the jacket alignment stripes 310 may preferably be wider than the base cover alignment stripes 210, thereby promoting ease of visually aligning the stripes. At block 430, the tail edge 318 of the flexible jacket 300 is secured to the transfer cylinder. In some embodiments, the flexible jacket 300 may further be secured to the transfer cylinder along the jacket operator side 314 and along the jacket gear side 312 by hook and fabric fasteners or by double sided tape or adhesive strip.

Turning now to FIG. 7, a method 500 for adjusting the flexible jacket 300 is described. At block 505, the jacket tail edge 318 of the flexible jacket 300 is released from the transfer cylinder 10, for example by pulling the flexible jacket 300 free of hook and fabric (i.e., VELCRO) patches retaining the flexible jacket 300 in place. The press operator may take note, prior to releasing the flexible jacket 300, how the horizontal stripes of the flexible jacket 300 align with respect to the horizontal stripes of the base cover 100. The method 500 may be performed because the free play in the flexible jacket 300 was not correctly adjusted or had progressively gotten out of adjustment through use. By taking note of the pre-adjustment alignment of horizontal stripes, the press operator may be more able to make the correct adjustment.

At block 510, the jacket tail edge 318 of the flexible jacket 300 is pulled smooth. The press operator may also smooth the flexible jacket 300 over the transfer cylinder 10 during this step. At block 515, the flexible jacket 300 is moved towards the gripper of the transfer cylinder 10 to provide a desirable amount of free play in the flexible jacket 300. At block 520, a visual stripe on the flexible jacket 300, for example one of the jacket alignment stripes 310, is aligned with a visual stripe on the base cover 100, for example one of the base cover alignment stripes 210. The alignment may be performed visually by a press operator. This step may involve partially seeing the visual stripe on the base cover 100 through the flexible jacket 300. At block 525, the jacket tail edge 318 of the flexible jacket 300 is secured to the transfer cylinder. In some embodiments, the flexible jacket 300 may further be secured to the transfer cylinder along the jacket operator side 314 and along the jacket gear side 312 by hook and fabric fasteners or by double sided tape or adhesive strip.

The base cover 100 with means for visual alignment and the flexible jacket 300 with means for visual alignment disclosed herein are simple, inexpensive, and provide advantages over previous anti-marking systems for transfer cylinders. The advantages of means for visual alignment can be obtained by the base cover 100 alone and/or in combination with the means for visual alignment on the flexible jacket 300. In some embodiments, different spacing of the alignment means on the base cover 100 with respect to the spacing of the alignment means on the flexible jacket 300 may provide a range of definite adjustment resolution. For example, in an embodiment, the spacing of the means for visual alignment on the base cover 100 are spaced about ¾ inch (about 1.9 cm) apart and the means for visual alignment on the flexible jacket 300 are spaced about ¾ inch (about 1.9 cm) apart.

In some embodiments, the base cover 100 and the flexible jacket 300 of the present disclosure may be packaged together and sold as an anti-marking kit for transfer cylinders, for example in a package containing at least one base cover 100 and at least one flexible jacket 300. In other cases, one base cover 100 may be combined in a package with a plurality of flexible jackets 300, for example six flexible jackets 300, and sold as a kit. As described in detail above, the base cover 100 of the kit has first means for visual alignment and/or visual stripes and the flexible jacket 300 of the kit has second means for visual alignment and/or visual stripes. In an embodiment, the kit may further include one or more backing sheets as described above, either adhered to the base cover 100 or not adhered to base cover 100. In an embodiment, the kit may further include one or more packing sheets as described above.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What we claim is:

1. In a printing unit having a transfer cylinder for transferring a freshly printed substrate, comprising:
a flexible jacket having at least one horizontally disposed first means for visual alignment; and
a base cover having at least one horizontally disposed second means for visual alignment, wherein the first means for visual alignment and the second means for visual alignment are used in combination during at least one of attaching the flexible jacket to the transfer cylinder over the base cover and adjusting the free play of the flexible jacket, wherein the flexible jacket is movable relative to the base cover.

2. The invention as defined in claim 1, wherein the base cover is removable.

3. The invention as defined in claim 2, wherein the base cover comprises at least one of a fiberglass fabric, a cotton fabric, a linen fabric, and a polyester fabric.

4. The invention defined in claim 1, wherein the base cover provides a low friction surface on an outer side of the base cover.

5. The invention as defined in claim 1, wherein the at least one horizontally disposed second means for visual alignment comprises a visual alignment stripe.

6. The invention as defined in claim 6, wherein the base cover comprises a woven fabric having weft threads and warp threads and wherein the visual alignment stripe is provided by the absence of one of at least one weft thread and at least one warp thread.

7. The invention as defined in claim 6, wherein the base cover further comprises at least one backing strip on an inside surface of the base cover, the backing strip overlapping the visual alignment stripe.

8. The invention defined in claim 5, wherein the visual alignment stripe is applied on the base cover by one of a painting process, a lithographic process, a silk screen process, and a laser induced marking process.

9. The invention as defined in claim 1, wherein the base cover comprises a plurality of horizontally disposed second means for visual alignment and wherein each second means for visual alignment is separated from adjacent second means for visual alignment by a substantially equal distance.

10. The invention as defined in claim 9, wherein each second means for visual alignment is separated from adjacent second means for visual alignment by a substantially equal distance, the substantially equal distance in the range from about ¼ inch to about 1 inch.

11. The invention defined in claim 10, wherein the flexible jacket comprises a plurality of horizontally disposed first means for visual alignment and wherein each first means for visual alignment is separated from adjacent first means for visual alignment by a substantially equal distance, the substantially equal distance in the range from about ¼ inch to about 1 inch.

12. The invention as defined in claim 9, wherein each second means for visual alignment is separated from adjacent second means for visual alignment by a substantially equal distance of about ¾ inch.

13. The invention defined in claim 12, wherein the flexible jacket comprises a plurality of horizontally disposed first means for visual alignment and wherein each first means for visual alignment is separated from adjacent first means for visual alignment by a substantially equal distance of about ¾ inch.

14. The invention as defined in claim 1, wherein the at least one horizontally disposed second means for visual alignment extends substantially from a first outer edge of the base cover to a second outer edge of the base cover.

15. The invention as defined in claim 1, wherein the at least one horizontally disposed second means for visual alignment has a length of less than about half the width of the transfer cylinder.

16. The invention as defined in claim 1, wherein the at least one horizontally disposed second means for visual alignment comprises an interrupted line.

17. In a printing unit having a transfer cylinder for transferring a freshly printed substrate having a base cover attached to the transfer cylinder and having a flexible jacket attached to the transfer cylinder over the base cover, the base cover characterized as comprising a first horizontal visual stripe, the flexible jacket characterized as comprising a sheet of flexible material having a second horizontal visual stripe for use, in combination with the first horizontal visual stripe, for visually aligning during attaching the flexible jacket to the transfer cylinder in an operative position wherein the flexible jacket is movable relative to the base cover.

18. The invention of claim 17, wherein the first horizontal visual stripe comprises at least one of at least one thread missing from a woven material comprising the base cover and a stripe painted on the base cover.

19. The invention of claim 17, wherein the base cover further comprises a backing to promote viewing the first horizontal visual stripe.

20. The invention of claim 19, wherein the backing comprises a single sheet of material that is substantially coextensive with the base cover.

21. The invention of claim 17, wherein at least one of the first horizontal visual stripe and the second horizontal visual stripe does not extend horizontally the width of the transfer cylinder.

22. A method of manufacturing a base cover for use in covering a transfer cylinder in a printing unit, wherein the base cover comprises at least one horizontally disposed means for visual alignment for visually aligning during at least one of attaching a flexible jacket to the transfer cylinder over the base cover and adjusting free play in the flexible jacket, comprising:
weaving a flexible material using warp and well threads, wherein a weft thread is periodically omitted from the material and wherein the omitted weft thread defines the at least one horizontally disposed means for visual alignment of the base cover.

23. The method of claim 22, further including cutting the flexible material into a plurality of sheets, each sheet comprising at least one omitted weft thread.

24. The method of claim 22, further including coating the flexible material on at least one surface with a low friction material.

25. The method of claim 22, further including adhering a backing to the flexible material at least proximate to the omitted weft thread, the backing promoting visual discernment of the omitted weft thread during attaching the flexible jacket to the transfer cylinder.

26. The method of claim 25, wherein the backing is substantially coextensive with the flexible material.

27. A method of attaching a flexible jacket over a transfer cylinder of a printing unit, comprising:
attaching a base cover to the transfer cylinder, the base cover having at least one horizontally disposed cover visual stripe;
attaching a gripper edge of a flexible jacket to the transfer cylinder, the flexible jacket having at least one horizontally disposed jacket visual stripe;
pulling a tail edge of the flexible jacket smooth;
moving the flexible jacket towards the gripper;
aligning the at least one cover visual stripe with the at least one jacket visual stripe, wherein a free play of the flexible jacket is adjusted; and
securing the tail edge of the flexible jacket to the transfer cylinder.

28. The method of claim 27, wherein the base cover comprises a plurality of horizontally disposed cover visual stripes equally separated, wherein the flexible jacket comprises a plurality of horizontally disposed jacket visual stripes equally separated, and wherein moving the flexible jacket towards the gripper comprises moving the flexible jacket towards the gripper one of a predefined number of jacket visual stripes and a predefined number of cover visual stripes.

29. A method of adjusting a flexible jacket attached to a transfer cylinder of a printing unit over a base cover attached to the transfer cylinder, the base cover having at least one horizontally disposed cover visual stripe and the flexible jacket having at least one horizontally disposed jacket visual stripe, comprising:
releasing the flexible jacket from the transfer cylinder at a tail edge of the flexible jacket;
pulling the flexible jacket smooth at the tail edge of the flexible jacket;
moving the flexible jacket towards the gripper;
aligning the at least one cover visual stripe with the at least one jacket visual stripe, wherein a free play of the flexible jacket is adjusted; and
securing the tail edge of the flexible jacket to the transfer cylinder.

30. An anti-marking kit for transfer cylinders, comprising:
At least one flexible jacket having at least one horizontally disposed first means for visual alignment; and
a base cover having at least one horizontally disposed second means for visual alignment, wherein the first means for visual alignment and the second means for visual alignment are used in combination during at least one of attaching the at least one flexible jacket to the transfer cylinder over the base cover and adjusting the free play of the at least one flexible jacket.

31. The invention as defined in claim 30, wherein the base cover comprises at least one of a fiberglass fabric, a cotton fabric, a linen fabric, and a polyester fabric.

32. The invention defined in claim 30, wherein the base cover provides a low friction surface on an outer side of the base cover.

33. The invention as defined in claim 30, wherein the at least one horizontally disposed second means for visual alignment comprises a visual alignment stripe.

34. The invention as defined in claim 33, wherein the base cover comprises a woven fabric having weft threads and warp threads and wherein the visual alignment stripe is provided by the absence of one of at least one weft thread and at least one warp thread.

35. The invention as defined in claim 34, wherein the base cover further comprises a backing sheet on an inside surface of the base cover, wherein the backing sheet has a color that contrasts with a color of the base cover.

36. The invention as defined in claim 34, wherein the base cover further comprises a backing sheet on an inside surface of the base cover, wherein the backing sheet comprises a metallic surface facing the inside surface of the base cover.

37. The invention as defined in claim 34, further including at least one packing sheet, wherein the at least one packing sheet has a color that contrasts with a color of the base cover or comprises a metallic surface facing the inside surface of the base cover.

38. The invention defined in claim 33, wherein the visual alignment stripe is applied on the base cover by one of a painting process, a lithographic process, a silk screen process, and a laser induced marking process.

39. The invention as defined in claim 30, wherein the base cover comprises a plurality of horizontally disposed second means for visual alignment and wherein each second means for visual alignment is separated from adjacent second means for visual alignment by a substantially equal distance.

40. The invention as defined in claim 39, wherein each second means for visual alignment is separated from adjacent second means for visual alignment by a substantially equal distance of about ¾ inch.

41. The invention defined in claim 40, wherein the at least one flexible jacket comprises a plurality of horizontally disposed first means for visual alignment and wherein each first means for visual alignment is separated from adjacent first means for visual alignment by a substantially equal distance of about ¾ inch.

42. The invention as defined in claim 30, wherein the at least one horizontally disposed second means for visual alignment extends substantially from a first outer edge of the base cover to a second outer edge of the base cover.

43. The invention as defined in claim 30, wherein the at least one horizontally disposed second means for visual alignment has a length of less than about half the width of the transfer cylinder.

44. The invention as defined in claim 30, wherein the at least one horizontally disposed second means for visual alignment comprises an interrupted line.
